(19) United States
(12) Patent Application Publication
(10) Pub. No.: US 2026/0348733 A1
(43) Pub. Date: Nov. 5, 2026

(54) LOG DATA-BASED ELECTRIC VEHICLE ENERGY CONSUMPTION ANALYSIS AND PATH EXPLORATION SYSTEM

(71) Applicant: SUNY Korea Research and Business Development Foundation, Incheon (KR)

(72) Inventor: Jongseong CHOI, Incheon (KR)

(21) Appl. No.: 19/664,845

(22) Filed: Apr. 30, 2026

(30) Foreign Application Priority Data
May 2, 2025 (KR) 10-2025-0058452

(51) Int. Cl. G01C 21/34; G01C 21/36

(52) U.S. Cl. CPC G01C 21/3446; G01C 21/3469; G01C 21/3492; G01C 21/362; G01C 21/367; G01C 21/3682

(57) ABSTRACT

A log data-based electric vehicle energy consumption analysis and path exploration system includes a mobile application module configured to receive user input and provide a user interface; a waypoint data management module configured to manage waypoint data including charging station locations; a path calculation module configured to generate a driving path and an encoded path string; a visualization module configured to decode the path string, display the path on a map, and support user interaction; a parameter estimation module configured to estimate, without additional sensors, energy consumption-related parameters including vehicle load and environmental conditions from initial driving log data including time, current, voltage, and speed; a prediction module configured to estimate remaining energy and driving range based on the estimated parameters; and a path optimization module configured to determine an optimal path, charging station locations, charging time, and driving speed using the estimated parameters and waypoint data.

### CROSS-REFERENCE TO RELATED APPLICATION

This present application claims priority to and the benefit under 35 U.S.C. § 119 (a)-(d) of Korean Patent Application No. 10-2025-0058452, filed on May 2, 2025, in the Korean Intellectual Property Office, the entire disclosure of which is incorporated herein by reference.

### BACKGROUND

### 1. Technical Field

The present disclosure relates to a log data-based electric vehicle energy consumption analysis and path exploration system.

### 2. Related Art

As electric vehicles (EVs) are extensively used, the necessity for navigation systems for sustainable long-distance driving is increasing. Navigation applications according to the related art calculate paths based on general vehicles and thus may not sufficiently reflect electric vehicle-specific requirements such as charging station locations, a battery remaining amount, and expected energy consumption. Therefore, electric vehicle drivers face problems such as uncertainty of charging station exploration during driving, anxiety about driving distances, and inefficient path planning.

Navigation systems according to the related art are designed to calculate paths based on general internal combustion engine vehicles and thus do not reflect electric vehicle-specific driving conditions and requirements. Since most existing systems simply provide charging station location information in the form of a database and do not provide real-time charging station availability information or a dynamic path recalculation function associated with a vehicle driving location, a driver may face a situation in which no charging is possible when arrived at a charging station.

In addition, electric vehicles require real-time path adjustment based on the remaining battery level; however, existing path exploration systems provide only simple distance- or time-based routes derived from static parameter sets, without reflecting actual driving conditions. Specifically, factors such as cargo load, number of passengers, ambient temperature, wind conditions, and road surface conditions can dynamically influence energy consumption and driving range, yet methods that incorporate these factors into battery state prediction do not exist. As a result, such systems may suggest routes that exceed the available driving range or lead to unnecessary charging stops. Consequently, drivers are often compelled to operate electric vehicles in an overly conservative manner. Furthermore, given that charging times are significantly longer than refueling times for internal combustion engine vehicles, accurately predicting arrival times becomes difficult. This limitation poses a significant barrier to the adoption of electric vehicles in industries where multi-vehicle scheduling is critical, such as logistics and public transportation.

In addition, since the related art has no function of reflecting parameters such as electric vehicle energy consumption models, charging cycles, battery charging rates, and vehicle-based driving efficiency, structural limitations are present in implementing electric vehicle-dedicated path optimization.

The aforementioned problems of the related art not only cause practical inconvenience to electric vehicle drivers, but also serve as main obstacle factors to efficient use and charging planning establishment of electric vehicles.

### SUMMARY

Various embodiments are directed to providing a log data-based electric vehicle energy consumption analysis and path exploration system that can solve driving distance anxiety of an electric vehicle driver and maximize charging efficiency by integrating charging station location information in real time, automatically readjusting driving paths according to a battery remaining amount of an electric vehicle, and providing a user-friendly map-based interface configured to intuitively visualize a long-distance path including a plurality of charging points.

Various embodiments are directed to providing a customized path exploration function including parameters such as energy consumption, charging station distribution, and available driving distance so that an existing general internal combustion engine vehicle-based path calculation API structure can be expanded and optimized according to electric vehicle driving conditions, and implementing the customized path exploration function with API, thereby enabling easy integration and utilization even in other applications or platforms.

Various embodiments are directed to guaranteeing user accessibility and scalability by providing a cross-platform structure that can identically run on both Android and iOS environments by utilizing a flutter framework and a Google Maps API, and to providing a practical path planning tool to electric vehicle drivers by integrating various functions such as real-time path generation, polyline rendering, and waypoint marker display.

Various embodiments are directed to providing a log data-based electric vehicle energy consumption analysis and path exploration system that can calculate vehicle energy consumption by using log data, and define parameters to provide an optimized path, charging location and time, and an optimal driving speed.

A log data-based electric vehicle energy consumption analysis and path exploration system according to the present disclosure includes: a mobile application module configured to receive user input and provide a user interface; a waypoint data management module configured to store and manage waypoint data including location information on a plurality of charging stations; a path calculation module configured to calculate a driving path including a plurality of waypoints based on the waypoint data, and to generate an encoded path string for the driving path; a visualization and interface providing module configured to decode the path string, to visualize the decoded string on a map, and to support a user interaction; a parameter estimation module configured to estimate, without additional sensors, parameters such as cargo load, number of passengers, ambient temperature, wind conditions, and road surface conditions from plots of initial driving log data (time, current, voltage, and speed) collected during the early stage of driving; a prediction module configured to estimate remaining energy and drivable range based on the estimated parameters; and a path optimization module configured to calculate an optimal path, a charging station location, a charging time, and a driving speed by using the estimated variables and the waypoint data.

The mobile application module is implemented based on a Flutter framework and is configured to support both Android and iOS operating system through a single codebase.

The mobile application module presents a plurality of alternative path candidates to a user, and the visualization and interface providing module is associated to display the path on the map according to a selection of the user.

The waypoint data management module stores the charging station information in a JSON format in the form of an object array including latitude and longitude coordinates.

The waypoint data management module receives real-time availability, a congestion level, and expected waiting time information for the charging station in association with an external API, and determines a priority of the waypoints.

The path calculation module calculates a path including a departure point, a destination, and the plurality of waypoints, and outputs the path as an encoded polyline string.

The visualization and interface providing module decodes the encoded polyline string, displays the path on the map, renders a marker corresponding to a waypoint location, and provides detailed information according to a touch of the user or a click event.

The visualization and interface providing module displays, on the map, information on the generated optimal path, the charging station location, the charging time, and a total driving time, and provides a zoom rendering function for each path section.

The visualization and interface providing module automatically updates a map UI according to a real-time state change, and reflects a state of a charging station marker through a color or an icon change.

The parameter estimation module estimates energy consumption variables based on time, speed, voltage, and current information included in the log data.

The parameter estimation module estimates the energy consumption variables including a gross vehicle mass, an air resistance coefficient, a rolling resistance coefficient, auxiliary power consumption, motor efficiency, a regenerative braking coefficient, and a battery capacity.

The parameter estimation module estimates the variables by using the vehicle log data collected within a preset time after the vehicle begins driving.

The path optimization module regards the charging stations as nodes, generates a cost map including a travel time between the nodes and the charging time as cost elements, and calculates the path that minimizes a total travel time.

The path optimization module calculates an optimal driving speed for each section and a charging time at each charging station and generates optimized path information.

The path optimization module dynamically adjusts a driving speed pattern in consideration of a driving scenario including highway driving, city driving, and hill section driving.

The present disclosure can solve the issue of insufficient charging station availability information occurring in an existing path exploration system, associate with an external API or a cloud-based database by using JSON-based charging station location data, integrate real-time charging station availability information, a congestion level, a charging time, etc., and provide the integrated information to users.

The present disclosure can provide a function capable of readjusting paths according to a battery state, automatically insert or change charging station waypoints at an appropriate time point during driving by reflecting a vehicle's current available driving distance data, and reduce the risk due to unnecessary stops at waypoints or missing charging stations.

The present disclosure can improve user satisfaction by providing a Flutter-based user interface and combining high-performance responsiveness with intuitive visual elements and clearly visualize complicated path exploration results through a polyline and a marker, thereby allowing users to directly zoom in and pan a map to check paths.

The present disclosure can be provided in the form of an API through function modularization to ensure expandability for easy integration into applications or platforms of other companies, and can be utilized in various fields such as B2B services, public transportation systems, and logistics platforms.

The present disclosure calculates energy consumption of an electric vehicle by using log data including battery voltage and current, defines parameters, and provides an optimized path, charging location and time, and an optimal driving speed.

Effects of the present disclosure are not limited to the aforementioned effects, and other effects not described above may be evidently understood by a person having ordinary knowledge in the art from the following description.

### BRIEF DESCRIPTION OF THE DRAWINGS

FIG. 1 illustrates a log data-based electric vehicle energy consumption analysis and path exploration system according to embodiments of the present disclosure.

FIG. 2 illustrates an optimal path.

FIG. 3 illustrates a UI screen of a mobile application according to embodiments of the present disclosure.

FIG. 4 illustrates a JSON data structure according to embodiments of the present disclosure.

FIG. 5 illustrates all forces acting on a vehicle.

FIG. 6 is a diagram illustrating JSON file-based charging station location information input-based path exploration results through Google Maps API according to embodiments of the present disclosure.

FIG. 7 is an enlarged diagram illustrating a section connecting two points in a polyline path according to embodiments of the present disclosure.

FIG. 8 is a diagram illustrating a log data-based electric vehicle energy consumption analysis and path exploration method according to embodiments of the present disclosure.

FIG. 9 is a diagram illustrating charging time and total travel time based on path optimization according to embodiments of the present disclosure.

FIG. 10 is a block diagram illustrating a computer system for implementing the method according to embodiments of the present disclosure.

### DETAILED DESCRIPTION

The above-described purpose, other purposes, advantages, and characteristics of the present disclosure and a method for achieving them will become apparent from the embodiments described in detail below in conjunction with the accompanying drawings.

However, the present disclosure is not limited to the disclosed embodiments, but may be implemented in various different forms. The embodiments below are merely provided to easily inform a person having ordinary knowledge in the art to which the present disclosure pertains of the purpose, configuration, and effect of the disclosure, and the scope of the present disclosure is defined by the description of the claims.

Terms used in this specification are used to describe embodiments and are not intended to limit the present disclosure. In this specification, an expression of the singular number includes an expression of the plural number unless clearly defined otherwise in the context. The term “includes” and/or “comprising” used in this specification does not exclude the presence or addition of one or more other elements, steps, operations, and/or elements in addition to a mentioned element, step, operation, and/or element.

Embodiments of the present disclosure provide a navigation system that generates a customized path considering charging station availability, remaining battery amount, energy consumption, etc., of an electric vehicle based on a Google Maps API and a Flutter framework, and provides the customized path as a user-friendly interface. Embodiments of the present disclosure have a technical feature of providing an integrated navigation system that generates a charging station-based optimal path for electric vehicle drivers by combining a Flutter framework-based mobile application with the Google Maps API and provides the generated optimal path as an intuitive user interface.

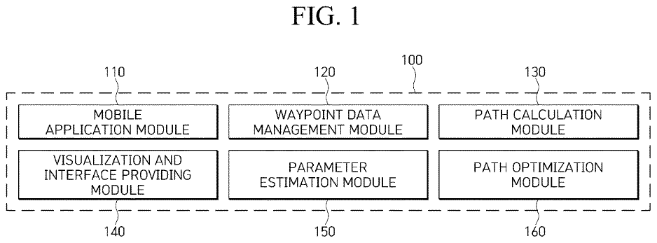

FIG. 1 illustrates a log data-based electric vehicle energy consumption analysis and path exploration system according to embodiments of the present disclosure. A log data-based electric vehicle energy consumption analysis and path exploration system 100 according to embodiments of the present disclosure includes a mobile application module 110, a waypoint data management module 120, a path calculation module 130, a visualization and interface providing module 140, a parameter estimation module 150, and a path optimization module 160.

The mobile application module 110 is configured to allow an electric vehicle driver to input a departure point and a destination, to explore an optimal path including charging station information, and to intuitively check detailed information on each path section and the state of each charging station on a map interface. The mobile application module 110 is implemented based on Flutter that is an open-source UI framework. The Flutter provides a cross-platform environment that can simultaneously run on Android and iOS operating systems with a single codebase, thereby maintaining interface consistency between both operating systems and significantly improving maintenance efficiency. According to embodiments of the present disclosure, compatibility and user experiences in various devices can be uniformly maintained.

The Flutter operates based on a Dart language and has GPU-based high-performance rendering engine therein, thereby providing an environment suitable for graphics-intensive applications such as electric vehicle path exploration. According to embodiments of the present disclosure, various visualization functions, such as map zooming in/out, charging station marker clicking, path polyline display, marker pop-up, and path highlighting, can be efficiently implemented through a Flutter's rich widget system.

After executing the mobile application, a user can input a departure point and a destination by text or clicking on a location on a map, and this information is internally structured and transmitted to the waypoint data management module 120 and the path calculation module 130. In addition to simple location coordinates, setting values such as user's preferred waypoint options, preference for the minimum number of times of charging, a shortest time standard, or a minimum energy standard are also structured and transmitted to the internal logic of the system. According to embodiments of the present disclosure, various paths can be generated according to destination arrival condition setting, and path optimization based on user needs is possible.

The mobile application module 110 includes an automatic update mechanism that automatically triggers a new path exploration command when a remaining battery amount rapidly decreases or it is determined that an estimated available driving distance is shorter than a distance to a next charging station. This mechanism allows the system to autonomously re-set paths without user intervention, thereby reducing a driver's cognitive burden and enhancing driving stability.

According to embodiments of the present disclosure, the Flutter SDK can be used to display an optimal path in the form of a polyline on a map screen and visualize each charging station location as a separate marker. Clicking on a marker on the map provides detailed information on the charging station, such as a real-time congestion level, waiting time, and chargeable capacity, in the form of a pop-up, and this information is frequently updated through an external charging station API. For example, real-time data can be reflected through external association through Supercharger API, Open Charge Map API, etc.

The user can remove specific waypoints from the map screen or add new waypoints to the map screen. In such a case, the mobile application module 110 internally structures the list of updated waypoints, and transmits the list to the path calculation module 130 so that new paths are automatically recalculated. The latest path generated in this way is immediately transmitted to the visualization and interface providing module 140 and reflected on the map screen in real time.

The map interface includes basic functions such as zooming in/out, map panning, returning to the current location, and differentially displaying path sections. When a plurality of alternative paths exist, the user can compare the paths on the map, comparative indicators such as the required time, estimated number of times of charging, and energy consumption for each path are provided together. Such a comparison function allows a driver to have more basis for decision-making when selecting a path, and provides a flexible and user-centered path selection function.

According to embodiments of the present disclosure, a state monitoring function allows the user to check a remaining battery amount in real time while driving and intuitively check the possibility of reaching a next charging station. When the battery state falls below a warning threshold, a visual notification is provided at the top of the screen or an alert is immediately provided to the user through an audio warning function.

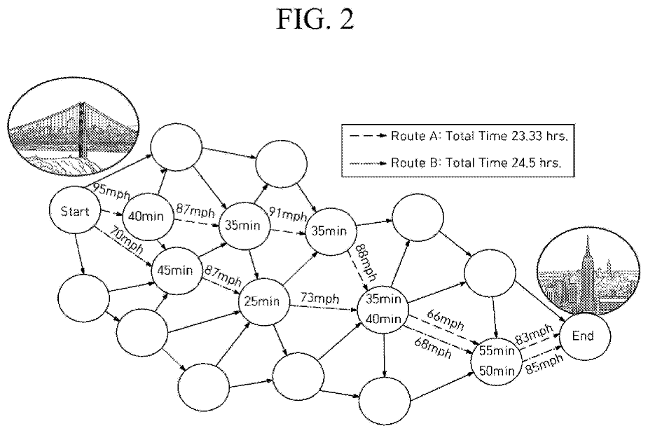

FIG. 2 illustrates an optimal path. In a Flutter application, a JSON file is parsed into a list of coordinates by using a built-in library, and the parsed data is transmitted to the Google Maps API to generate markers for supercharger locations and render a continuous polyline path. The flexibility of JSON facilitates updates and guarantees seamless integration and efficient processing of location data. This has the effect of effectively visualizing paths and providing clear navigation paths to electric vehicle drivers.

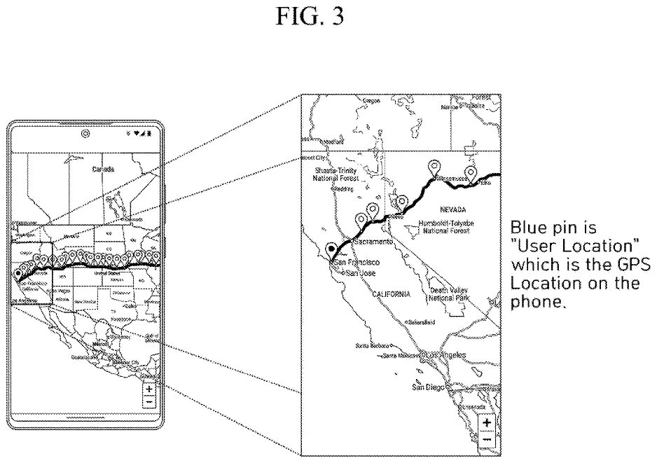

FIG. 3 illustrates a UI screen of the mobile application according to embodiments of the present disclosure. Referring to FIG. 3, the Flutter SDK is utilized to display an optimal path on a map in the form of a polyline, and charging stations are visualized as markers. Such a screen allows the user to ascertain the entire path at a glance and to check detailed information on each charging station.

The waypoint data management module 120 systematically collects waypoint information such as a plurality of charging stations existing between the departure point and the destination designated by the user, stores the collected waypoint information in a structured format, and dynamically updates or filters the stored information as needed. The waypoint data management module 120 ensures the quality, accuracy, and up-to-dateness of the waypoint information provided to the path calculation and path optimization module 160 as an input value, thereby guaranteeing overall system reliability and path exploration performance.

According to embodiments of the present disclosure, waypoint data is managed based on a JavaScript object notation (JSON) format, and JSON is a data representation format with a key-value pair structure and can configure a plurality of charging station information in an object array format. Each object is designed to include various attributes such as latitude, longitude, charging station name, maximum output power maxPower, availability, expected waiting time waitingTime, and the number of connected ports portCount.

For example, in a scenario of a long-distance electric vehicle travel from Los Angeles to New York, 30 or more supercharger charging station data existing on a path are pre-stored in a JSON file, the user executes the application, and simultaneously the JSON file is loaded into a memory and used as input for the path calculation module 130. According to embodiments of the present disclosure, the initial response speed of the application is increased and basic path exploration is enabled even in offline environments, thereby improving system accessibility and reliability.

According to embodiments of the present disclosure, in addition to a data storage and import function, charging station-related information can be updated in real time through association with various external APIs. That is, an external data providing service such as Supercharger API or Open Charge Map API is called to collect the current available state of each charging station, a charging port congestion level, a malfunction state, etc., and this information is dynamically merged into or replaces an existing JSON object. This enables dynamic path exploration based on real-time information, instead of simple static path exploration based on historical data.

The waypoint data management module 120 converts the collected JSON data into an object list format through a built-in parser in a Dart language, processes the object list into a form displayable on the map, and then transmits the processed list to the path calculation module 130 or the visualization and interface providing module 140. The parsed charging station list can be conditionally realigned through a list operation or a filtering operation. For example, when the vehicle's remaining battery amount drops below a specific threshold, waypoints can be dynamically reconfigured by extracting only charging stations within a reachable range from the current location, selecting only charging stations with a charging state “Available” from the extracted charging stations, and putting the selected charging stations into a path.

The waypoint data management module 120 is configured to implement various priority algorithms based on waypoint selection criteria. The waypoint data management module 120 can automatically align or select charging stations based on criteria such as output power, expected waiting time, charging fee, and brand preference among charging stations, and dynamically adjust the weights of these criteria according to user input or vehicle states. For example, when the vehicle's remaining battery amount is very low, the waypoint data management module 120 can be configured to preferentially select superchargers with high maximum power output and set a charging station that can be reached in the shortest time as a waypoint.

According to embodiments of the present disclosure, a function is provided to update the waypoint list according to real-time changes in driving conditions, thereby allowing the system to recalculate paths by itself and reflecting new waypoint information when battery consumption rapidly increases or the estimated arrival time is delayed while driving on a highway.

The waypoint data is also utilized in the cost calculations of the path optimization module 160. The waypoint location information forms each node and is used to configure a cost map between nodes including the distance between waypoints, the required time, the charging time, etc. The waypoint data serves as a key input value for mathematical path optimization techniques.

The waypoint data management module 120 also provides user input-based waypoint addition and deletion functions, allowing the user to designate new waypoints or remove existing waypoints on the map UI. Such storage/removal information is reflected in the JSON structure in real time and is transmitted to the path calculation module 130 after internal parsing. The interaction-based data update enables user-customized path setting. The waypoint data management module 120 not only serves as a simple information storage, but also determines the flexibility and accuracy of the overall system operation.

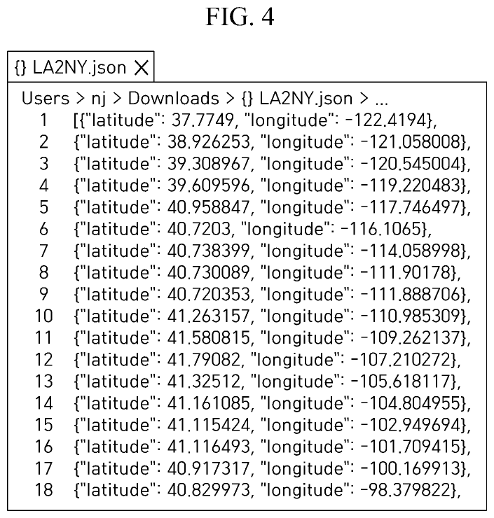

FIG. 4 illustrates the JSON data structure according to embodiments of the present disclosure. Referring to FIG. 4, the JSON file is configured as an array of a plurality of objects, and each object includes latitude and longitude information of one charging station. Such a structure is utilized as the basic unit for data parsing and path generation automation.

The JSON data is parsed into a list format through a Dart's built-in library and a data preprocessing function such as filtering charging stations or rearranging an order can be performed according to specific conditions (e.g., a remaining battery amount, weather, a charging station congestion level, etc.). In addition, through association with external APIs, information on charging station availability and a congestion level can be updated in real time, thereby enabling dynamic path calculations other than static path calculations.

The path calculation module 130 calculates an optimal path by integrating the information on the departure point and the destination input by the user and the location information of the plurality of charging stations received from the waypoint data management module 120. The path calculation module 130 performs initial calculations for path generation and serves as a foundation for determining the consistency and quality of input values transmitted to the path optimization module 160.

The path calculation module 130 configures a path exploration request including the departure point, the destination, and the waypoints in an API format, and calls the path exploration request to perform path generation. The Directions API receives a plurality of points, calculates a path connecting the points in an optimal order, and returns the calculation results in a JSON format. The returned path information includes the total distance, estimated required time, distance and time information on each detailed section, road type, traffic conditions, etc.

According to embodiments of the present disclosure, the path calculation result is converted into an encoded polyline string in a compressed format, and efficient data transfer is performed when associated with the visualization and interface providing module 140. The encoded polyline can represent thousands of latitude/longitude coordinate pairs as a compressed string, and provides a structure capable of accurately representing paths on the map. The string is interpreted in real time by the Flutter SDK's built-in decoder and rendered as paths on the map.

The path calculation module 130 can repeatedly recalculate paths according to user requests or changes in the vehicle state. For example, when the vehicle's remaining battery amount rapidly decreases and limits the number of waypoints that can be reached or when the real-time congestion level at a specific charging station rapidly increases and the priority is lowered, the path calculation module 130 receives a new list of waypoints from the mobile application module 110 or the waypoint data management module 120 and recalculates paths based on the received new list. The path calculation module 130 supports a differential recalculation method of modifying only a part of the existing path, and can selectively perform a method of regenerating the entire path from the beginning.

The path calculation module 130 also includes a function of generating a plurality of alternative paths. The Directions API provides an option capable of returning a plurality of path candidates during path exploration, and can present various path options to the user according to embodiments of the present disclosure. For example, by simultaneously calculating candidate paths by type such as the fastest path or a path with the lowest expected energy consumption and providing choices to the user, the customization of path setting can be maximized.

The path calculation module 130 can also provide detailed information on each section in consideration of factors such as a distance between charging stations included in a path, elevation changes, and expected road conditions. Since energy consumption is likely to increase in a section with large elevation changes, the information is then transmitted to the parameter estimation module 150 or the path optimization module 160 to serve as the basis for more sophisticated calculations. This allows the path calculation to perform a more comprehensive function including the generation of basic data for energy-based prediction beyond simple coordinate connection.

The path calculation module 130 converts the path data received in a JSON format into object information. The object information includes start and end coordinates, distance, time, expected traffic conditions, road type, etc., for each section between waypoints, and is used to configure a cost map for an optimization algorithm. The path calculation results are designed to be integrated into an optimization process and prevent an unnecessary conversion process or information loss during data transmission.

The path calculation module 130 can perform a certain level of preprocessing and filtering function beyond simply receiving and transmitting API response data. For example, when a path with an extremely long required time is included in the same section, a logic for excluding or replacing the section can be automatically executed, and when a path between some points bypasses a highway, restrictions on road types can be applied according to user setting values. The preprocessing function contributes to ensuring both practicality and accuracy of paths at the same time, and also guaranteeing the quality of paths provided to the user.

The path calculation module 130 can be implemented in the form of an application programming interface (API) for use in external application systems or platforms. For example, a large cargo electric vehicle transport platform, a logistics management system, a smart city traffic management platform, etc., can call the path calculation function and integrate the path calculation function into an internal system, and such a structure ensures both scalability for B2B markets and commercial applicability at the same time.

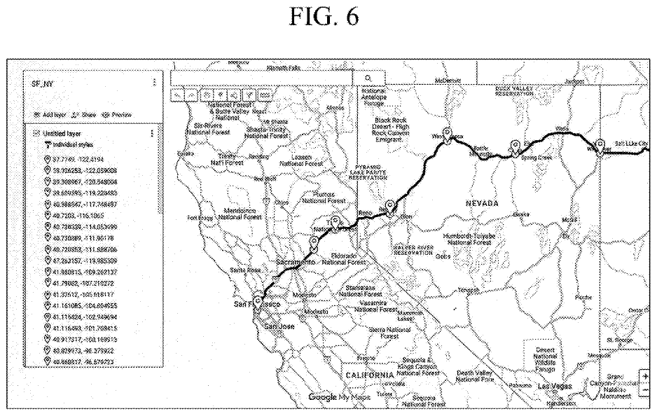

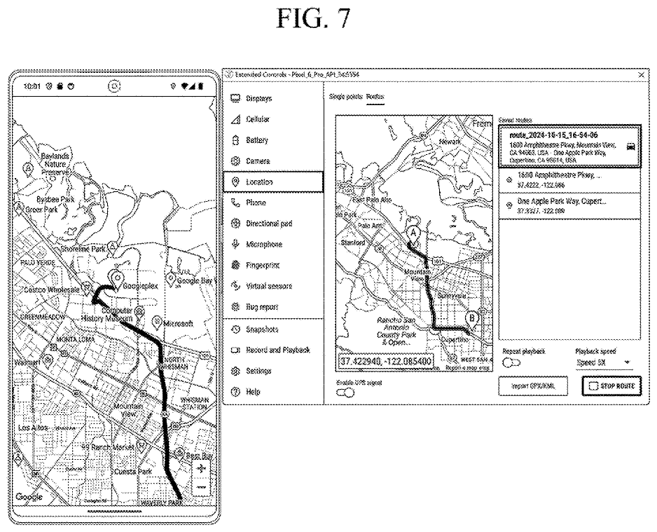

FIG. 6 is a diagram illustrating JSON file-based charging station location information input-based path exploration results through Google Maps API according to embodiments of the present disclosure. A path connecting 30 charging stations from Los Angeles to New York is visually implemented on the map, and this data is automatically generated through the API. FIG. 7 is an enlarged diagram illustrating a section connecting two points in a polyline path according to embodiments of the present disclosure.

The path calculation module 130 automates the API call process, responds to user input events, and recalculates the latest path in real time whenever waypoint data is updated. For example, when the user manually removes or changes an intermediate waypoint or when the vehicle's remaining battery amount is reduced and it is determined that it is not reachable a destination on the current path, the path calculation module 130 automatically reflects such conditions and calculates a new path.

The visualization and interface providing module 140 plays a role of transmitting path exploration results to the user, displays paths on a map-based interface, expresses each waypoint as a visual marker, and processes various interactions with the user. This module is mainly configured using a map widget based on the Google Maps Flutter SDK.

The visualization and interface providing module 140 is a core component of a user interface (UI) that helps user's visual perception and enables an intuitive interaction with the system, and includes a multifunctional rendering processor that visually displays, on the map, path data generated by the path calculation module 130 and the path optimization module 160, enables an interaction with charging station markers and waypoint information, and performs real-time information reflection and UP update according to user operations on the map.

The visualization and interface providing module 140 decodes the encoded polyline path data received from the path calculation module 130, converts the decoded data into a continuous pair of latitude and longitude coordinates, and then renders the converted data on the map in the form of a polyline. The polyline is implemented as similarly as possible to an actual road shape on the map, and curve sections, highway entrance sections, city road junctions, etc., are also expressed naturally. Such decoding and rendering can be implemented using built-in methods of the Flutter SDK or through a customized decoder class.

Markers representing charging stations, user-designated waypoints, destinations, etc., that constitute a path are displayed on the map. Each marker includes unique information on a corresponding location, and when the user clicks or touches a corresponding marker, an information pop-up InfoWindow is displayed on the map to provide detailed information such as the real-time state of a charging station, expected waiting time, output power, and operating hours. This information is updated in real time through an external API or an internal data management module, and the visualization and interface providing module 140 periodically receives the information and dynamically updates marker properties on the map UI.

The user can freely select a marker on the map and has a function capable of adding or removing a selected charging station to/from the waypoint list. Such a function is designed to structure user input values in real time in association with the mobile application module 110 and transmit the structured values to the waypoint data management module 120 and the path calculation module 130. Accordingly, the visualization module is also utilized as an interface for input triggers beyond the simple output function.

The map interface basically provides zooming in/out functions, map panning, a current location center shift function, etc. The zooming in/out functions can be performed using two-finger gestures or button clicks, and also include a function of automatically zooming in a corresponding location when a specific marker or a waypoint is clicked. Such a UI operation helps the user intuitively ascertain an entire path or a specific section.

When a plurality of path candidates exist, the visualization and interface providing module 140 distinguishes the path candidates with different colors, and simultaneously displays the path candidates on the map, and expresses a selected path by a highlighted line. For example, the fastest path can be distinguished by a blue solid line, a path including the fewest charging stations can be distinguished by a green dotted line, and a path with the lowest energy consumption can be distinguished by an orange wavy line. Such path styles can be changed according to user setting.

The visualization and interface providing module 140 also provides a path section zoom-in function. When the user touches or zooms in a specific path section, a detailed path of the section is displayed as a more precise curve, and rendering is performed as similarly as possible to an actual road shape. For example, highway curves, interchange entrance and exit roads, and complex urban road networks are enlarged and displayed in high resolution, so that path readability is improved.

The visualization and interface providing module 140 includes a visual feedback function according to real-time state changes. For example, when a specific charging station is temporarily unavailable, a corresponding marker is turned gray or an “X” is added thereto. When a charging station is very busy, a timer icon indicating a waiting time is displayed at the top of the marker. However, when a charging station is available, a marker is turned green, and in a case of a supercharger that can be quickly charged, a lightning-shaped icon can be displayed as well. Such a visual feedback allows a driver to immediately ascertain the state of charging stations on the map in real time, and enables intuitive determination without unnecessary touches or exploration. The visualization and interface providing module 140 is also designed to associate with a voice guidance system. When path exploration is started, information on the current location, a next waypoint, an estimated arrival time, etc., is audibly output, and real-time notifications are also provided when a charging station is approaching or when a path is changed. This function provides functional advantages of reducing a driver's visual burden and supporting safe driving during driving.

Based on the Flutter's responsive UI structure, the visualization and interface providing module 140 can dynamically adjust the map UI layout according to the state of the user's device (e.g., switching between portrait and landscape modes, screen size adjustment, etc.). This is very effective in providing the same visual experience in various devices (e.g., smartphones, tablets, embedded displays in vehicles), and enables user-centered interface design.

The parameter estimation module 150 performs a function of quantitatively calculating main physical variables constituting an energy consumption model based on real-time or historical vehicle driving log data. The parameter estimation module 150 serves as a core component in a preprocessing stage of the path optimization module 160 for enabling more precise and realistic path calculations, and provides numerical basic information essential for predicting energy that is to be consumed by an electric vehicle under actual road and load conditions.

The energy consumption of an electric vehicle is affected by various factors. In general, physical factors such as rotational loss, rolling resistance, air resistance, gravity, and additional power consumption operate in a complex manner, and the influence of these factors is changed in real time according to external variables such as vehicle load, road slope, wind resistance, tire condition, motor efficiency, temperature, and driving speed. These external variables may include vehicle load conditions such as cargo load and number of passengers, as well as environmental conditions such as ambient temperature, wind conditions, and road surface conditions. Accordingly, for accurate path optimization, it is necessary to analyze data of a vehicle driven for a certain period of time, reversely estimate these variables, and establish future driving paths and charging strategies based on these results.

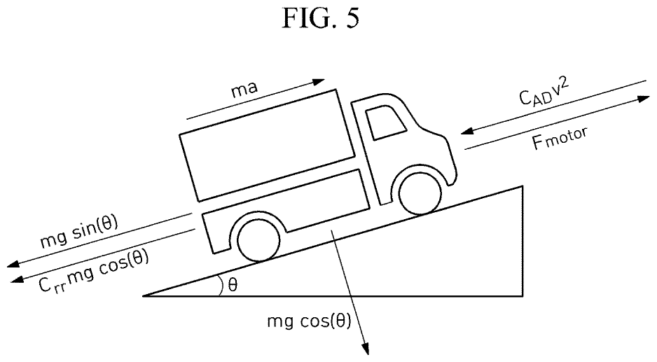

FIG. 5 illustrates all forces acting on a vehicle. Such forces are used in the energy consumption model.

In order to achieve the above purpose, the parameter estimation module 150 uses, as input, log data collected in real time or in the past from the vehicle. The parameter estimation module 150 estimates the parameters based on vehicle log data without requiring additional dedicated sensors. The log data generally includes the following items: time (timestamp), vehicle speed (speed), battery voltage (voltage), battery current (current), accumulated driving distance (odometer), outside temperature (temperature), GPS-based elevation (elevation), etc. The present disclosure calculates the following main parameters by performing regression analysis or physics-based model inference based on such data:
Gross vehicle mass (m): Actual mass including all weights such as the weight of loaded cargo, the number of driver and passengers, and fuel or liquids.
Air resistance coefficient (Cd): Drag factor that is used together with the frontal area (A) of the vehicle and air density (ρ), and increases resistance in proportion to speed.
Rolling resistance coefficient (Cᵣᵣ): Varies depending on road surface conditions, tire wear and pressure, and vehicle load, and causes energy loss at a constant rate per mile driven.
Auxiliary power consumption (P_{AC}): Total power consumption unrelated to vehicle operation such as heating, cooling, audio, lighting, and electronic equipment.
Motor efficiency (η): Ratio of energy converted to actual propulsive force compared to battery power.
Regenerative braking ratio (regen ratio): Ratio of energy returned to battery during braking.
Total battery capacity (CTB): Total energy stored when fully charged. This may vary with temperature and battery aging.
In embodiments of the present disclosure, relationships are applied to estimate these parameters.

Fₘₒₜₒᵣ−mg sin(θ)−Cᵣᵣmg cos(θ)−C_{AD}V²=ma Equation 1

In Equation 1 above, Fₘₒₜₒᵣ is a total propulsive force generated by a motor, m is a vehicle mass, a is an acceleration, θ is a road slope angle, v is a speed, and ρ is air density.

$${F}_{motor} = \frac{η ( BP ) t}{d} \qquad Equation 2$$

In Equation 2 above, BP represents battery power, t represents a time interval, and d represents a travel distance.

The battery power is expressed by the following Equation in terms of voltage and current provided by the log data.

BP=IV−P_{AC} Equation 3

Fₘₒₜₒᵣ is expressed by the following Equation.

$${F}_{motor} = \frac{η ( IV - {P}_{A C} )}{v} \qquad Equation 4$$

The aforementioned Equation can be summarized as follows.

$$\frac{η ( IV - {P}_{A C} )}{v} - m g sin ( θ ) - {C}_{rr} m g cos ( θ ) - {C}_{A D} {v}^{2} = ma \qquad Equation 5$$

The parameter estimation module 150 plays a key role in performing real-time numerical modeling based on vehicle dynamics to increase the accuracy of path optimization and providing the user with highly reliable driving plans, beyond simple sensor data collection.

The path optimization module 160 calculates an optimal path that minimizes total driving time or energy consumption based on path candidates and an energy consumption model input during or before driving. The path optimization module 160 is fundamentally different from existing simple path exploration systems focused on the shortest distance or the shortest time, and is designed to optimize a multidimensional objective function in consideration of complex factors such as actual dynamic characteristics of electric vehicles, charging time, battery reserve, distance between charging stations, and the state of each charging station. The path optimization module 160 configures a waypoint graph including charging station candidates that can be reached, generates a cost map based on the time and energy cost required to travel between nodes (charging stations), derives an optimal path that minimizes total driving time or total number of times of charging by using the cost map as input, calculates an optimal driving speed and a charging time for each section of the optimal path, visually outputs optimal path results, and processes path change triggers. The prediction module estimates a remaining energy and a drivable range of the electric vehicle based on the parameters estimated by the parameter estimation module 150. The prediction module predicts an available driving distance under current driving conditions and provides the prediction results to the path optimization module 160 for path planning.

The nodes in the graph are defined as a charging station, a departure point, and a destination, and edges between the nodes include multiple cost factors that reflect the distance and time that a vehicle can reach on a corresponding path section, energy consumption, road gradient, etc.

The path optimization module 160 first configures a graph of the entire path based on the list of waypoints and distance information received from the waypoint data management module 120 and the path calculation module 130. Each node in the graph represents a charging station location, and each edge includes information on the time required for the vehicle to drive a corresponding section, energy consumption, and expected charging time. The cost of each edge is calculated as a weighted sum.

The weights representing the relative importance of each element can be dynamically adjusted according to user setting or system conditions. For example, when a driver selects a “shortest time” mode or prefers “minimum number of times of charging”, the weights are set differently.

After the cost map is configured, a path with the lowest cost among possible paths to the destination is explored. Conditional branches are included to verify the battery state of each node and the availability of travel to the next node, and the possibility of reaching the next node is checked.

When an optimized path is fixed, a driving speed in each section and a charging time at a charging station are also calculated. The driving speed is determined according to the energy consumption function provided by the parameter estimation module 150.

An optimal driving speed in a corresponding section is derived and the charging time is calculated. When a charging station is busy or power is limited, the charging time relatively increases.

In addition to performing static optimization, the path optimization module 160 is configured to re-explore a path in real time when the battery state rapidly changes or the availability of charging stations changes during vehicle driving. For example, when a vehicle consumes power earlier than expected and is not able to reach a next charging station, the system calculates new reachable charging stations based on the current location and partially reconfigures the existing path.

Such re-exploration is automatically performed without user intervention and is reflected on the screen in real time in association with the mobile application module 110 and the visualization and interface providing module 140. Details of path changes, newly added charging stations, and changes in an expected arrival time are also displayed together.

The path optimization module 160 also includes a path constraint condition processing function considering realistic driving conditions. For example, conditions such as setting specific charging stations as unavailable (due to malfunctions, maintenance, etc.), excluding nighttime restricted driving sections, and prioritizing highways or general roads can be applied during path exploration.

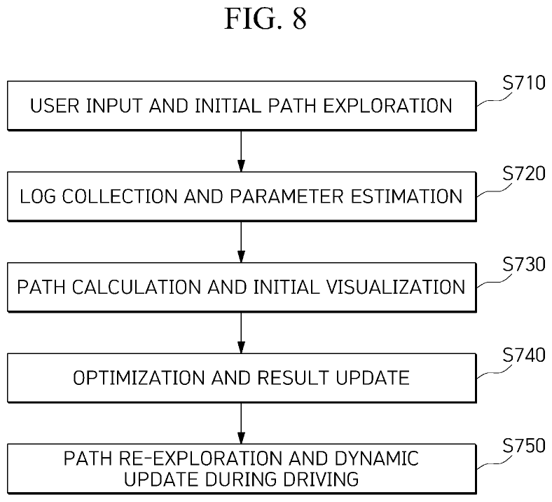

FIG. 8 is a diagram illustrating an electric vehicle path exploration method according to embodiments of the present disclosure.

In step S710, user input and initial path exploration are performed. The user inputs a departure point and a destination. The input is performed based on a place name text or by selecting locations on a map, and the user can also input preferred waypoints, sections to avoid, or preferred path conditions (e.g., the minimum number of times of charging, maximum speed priority, etc.). The input values are internally converted into a structured format, and data on charging stations located in a corresponding section is imported in a JSON format. At this time, in addition to basic location information of the charging station, the real-time state (e.g., queue, operation state, expected charging speed, etc.) thereof is also updated via an external API.

In step S720, log collection and parameter estimation are performed. When the vehicle is started and begins driving, the system begins collecting log data. Data on speed, voltage, current, elevation, etc., for about five minutes of initial driving are analyzed to calculate a gross vehicle mass (including cargo), an air resistance coefficient, a rolling resistance coefficient, auxiliary power consumption, motor efficiency, and a battery capacity. These variables are core data constituting an energy consumption prediction model, and enable precise calculations of an expectable maximum driving distance, the possibility of reaching a charging station, etc., when the vehicle drives at a constant speed in the future.

In step S730, path calculation and initial visualization are performed. Based on the list of the departure point-destination-waypoints, an API is called to generate an initial path in the form of an encoded polyline. This path is a simple distance-based optimal path and does not yet reflect an optimal speed, a charging time, etc. The generated path is displayed as a polyline on a map. Each charging station is marked with a marker, and when the marker is clicked, detailed information (a congestion level, availability, expected waiting time, etc.) can be checked.

In step S740, optimization and result update are performed. An optimal path is explored based on the parameters and the path data. Finally, the optimal path that satisfies reachability and efficiency, the total required time, the dwell time at each charging station, and changes in the state of charge (SOC) are calculated. These results are visualized on the map UI, and the user can check the total required time, the number of times of charge, expected arrival time, etc., at a glance, and can also select one among path candidates as needed.

In step S750, path recalculation and dynamic update are performed during driving. While driving, the system continuously collects log data and detects changes in remaining battery amount, current speed, and the state of charging stations to be passed through in real time. When specific conditions (e.g., a remaining battery amount is reduced earlier than expected, a queue longer than expected occurs at a charging station, an expected arrival time is delayed due to road conditions, the user changes a waypoint or a destination, etc.) are satisfied, the system automatically recalculates paths.

According to embodiments of the present disclosure, the system was applied to a long-distance driving scenario from Los Angeles (LA) to New York in United State of America and was verified. Thirty supercharger charging stations were included as waypoints over a total distance of about 4,500 km. The latitude/longitude information of each charging station was stored in a JSON file and then called by the system. After an initial path is generated and the vehicle begins driving, log data was collected and parameters were estimated for about five minutes. Based on these results, a path including an optimal speed for each travel section between charging stations and an estimated dwell time at each charging station was calculated with respect to an entire path. Finally, the system proposed an entire travel path including about seven-time charging, and the total required time was about 6.2% shorter than the path proposed by the existing Tesla Trip Planner. In particular, the system succeeded in reducing an actual waiting time by automatically performing path re-exploration in the latter half of the path in consideration of a charging station congestion level.

In this way, the entire system of the present disclosure has technical features of providing a next-generation EV navigation solution capable of providing an actually available high-precision optimal path, beyond simple path exploration, by operating based on a multi-layered response structure that considers real-time driving condition changes from user input and comprehensively implementing energy consumption prediction, formula-based path optimization, and advanced visualization function.

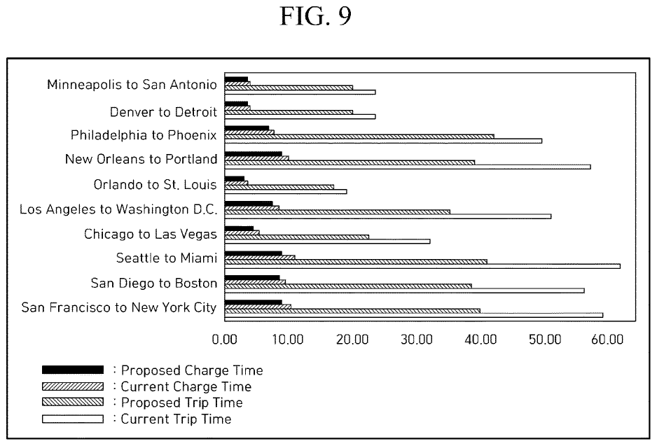

FIG. 9 illustrates charging time and total travel time based on path optimization according to embodiments of the present disclosure. FIG. 9 illustrates both the charging time and the total travel time for a designated path when an 1800 kg vehicle is driven in the summer by comparing the current method (related art) with the path optimization method according to embodiments of the present disclosure. As a result of performing tests on 19 different paths, according to embodiments of the present disclosure compared to the related art, the driving time is reduced by about 10% for short driving and about 33% for long driving.

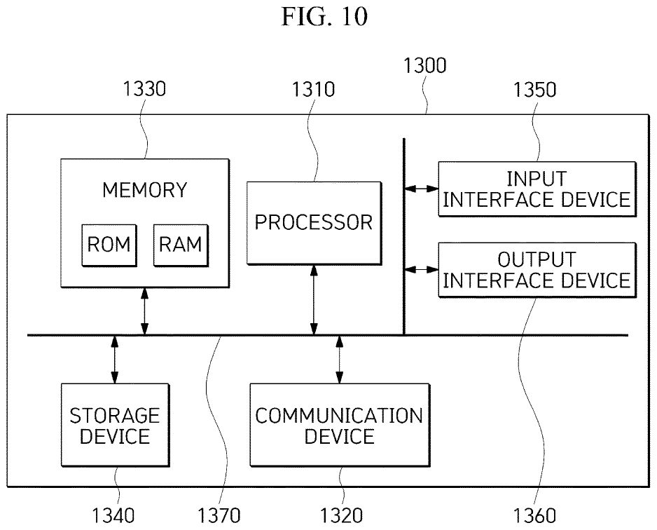

FIG. 10 is a block diagram illustrating a computer system for implementing the method according to embodiments of the present disclosure.

Referring to FIG. 10, a computer system 1300 may include at least one of a processor 1310, a memory 1330, an input interface device 1350, an output interface device 1360, and a storage device 1340 that communicate with one another through a bus 1370. The computer system 1300 may also include a communication device 1320 coupled to a network. The processor 1310 may be a central processing unit (CPU) or a semiconductor device that executes instructions stored in the memory 1330 or the storage device 1340. The memory 1330 and the storage device 1340 may include various types of volatile or nonvolatile storage media. For example, the memory may include a read only memory (ROM) and a random access memory (RAM). In embodiments of the present disclosure, the memory may be located inside or outside the processor, and may be connected to the processor through various known means. The memory is various forms of volatile or nonvolatile storage media, and for example, may include a read-only memory (ROM) or a random access memory (RAM).

Accordingly, embodiments of the present disclosure may be implemented as a computer-implemented method or a non-transitory computer-readable medium storing computer-executable instructions. In an embodiment, when executed by a processor, computer readable instructions may perform a method according to at least one aspect of the present disclosure.

The communication device 1320 may transmit or receive wired signals or wireless signals.

The method according to embodiments of the present disclosure may be implemented in the form of program instructions that can be executed through various computer means, and recorded on a computer-readable medium.

The computer-readable medium may include program instructions, data files, data structures, and the like singly or in combination. The program instructions recorded on the computer-readable medium may be specially designed and configured for embodiments of the present disclosure, or may be known to and usable by those skilled in the art of computer software. A computer-readable recording medium may include a hardware device configured to store and execute program instructions. Examples of the computer-readable recording medium may include magnetic media such as hard disks, floppy disks, and magnetic tapes, optical media such as CD-ROMs and DVDs, and magneto-optical media such as floptical disks, a ROM, a RAM, and a flash memory. The program instructions may include not only machine language code such as that generated by a compiler, but also high-level language code that can be executed by a computer through an interpreter or the like.

Although the embodiments of the present disclosure have been described in detail above, the scope of the present disclosure is not limited thereto, and various modifications and improvements made by those skilled in the art using the basic concept of the present disclosure defined in the following claims are included in the scope of the present disclosure.

What is claimed is:

1. A log data-based electric vehicle energy consumption analysis and path exploration system comprising:
a mobile application module configured to receive user input and provide a user interface;
a waypoint data management module configured to store and manage waypoint data including location information on a plurality of charging stations;
a path calculation module configured to calculate a driving path including a plurality of waypoints based on the waypoint data, and to generate an encoded path string for the driving path;
a visualization and interface providing module configured to decode the path string, to visualize the decoded string on a map, and to support a user interaction;
a parameter estimation module configured to collect and analyze vehicle log data, to estimate parameters affecting energy consumption of an electric vehicle, and to output a variable value; and
a path optimization module configured to calculate an optimal path, a charging station location, a charging time, and a driving speed by using the variable value and the waypoint data.

2. The log data-based electric vehicle energy consumption analysis and path exploration system of claim 1, wherein the mobile application module is implemented based on a Flutter framework and is configured to support both Android and iOS operating system through a single codebase.

3. The log data-based electric vehicle energy consumption analysis and path exploration system of claim 1, wherein the mobile application module presents a plurality of alternative path candidates to a user, and the visualization and interface providing module is associated to display the path on the map according to a selection of the user.

4. The log data-based electric vehicle energy consumption analysis and path exploration system of claim 1, wherein the waypoint data management module stores the charging station information in a JSON format in the form of an object array including latitude and longitude coordinates.

5. The log data-based electric vehicle energy consumption analysis and path exploration system of claim 1, wherein the waypoint data management module receives real-time availability, a congestion level, and expected waiting time information for the charging station in association with an external API, and determines a priority of the waypoints.

6. The log data-based electric vehicle energy consumption analysis and path exploration system of claim 1, wherein the path calculation module calculates a path including a departure point, a destination, and the plurality of waypoints, and outputs the path as an encoded polyline string.

7. The log data-based electric vehicle energy consumption analysis and path exploration system of claim 6, wherein the visualization and interface providing module decodes the encoded polyline string, displays the path on the map, renders a marker corresponding to a waypoint location, and provides detailed information according to a touch of the user or a click event.

8. The log data-based electric vehicle energy consumption analysis and path exploration system of claim 1, wherein the visualization and interface providing module displays, on the map, information on the generated optimal path, the charging station location, the charging time, and a total driving time, and provides a zoom rendering function for each path section.

9. The log data-based electric vehicle energy consumption analysis and path exploration system of claim 1, wherein the visualization and interface providing module automatically updates a map UI according to a real-time state change, and reflects a state of a charging station marker through a color or an icon change.

10. The log data-based electric vehicle energy consumption analysis and path exploration system of claim 1, wherein the parameter estimation module estimates energy consumption variables based on time, speed, voltage, and current information included in the log data.

11. The log data-based electric vehicle energy consumption analysis and path exploration system of claim 10, wherein the parameter estimation module estimates the energy consumption variables including a gross vehicle mass, an air resistance coefficient, a rolling resistance coefficient, auxiliary power consumption, motor efficiency, a regenerative braking coefficient, and a battery capacity.

12. The log data-based electric vehicle energy consumption analysis and path exploration system of claim 10, wherein the parameter estimation module estimates the variables by using the vehicle log data collected within a preset time after the vehicle begins driving.

13. The log data-based electric vehicle energy consumption analysis and path exploration system of claim 1, wherein the path optimization module regards the charging stations as nodes, generates a cost map including a travel time between the nodes and the charging time as cost elements, and calculates the path that minimizes a total travel time.

14. The log data-based electric vehicle energy consumption analysis and path exploration system of claim 13, wherein the path optimization module calculates an optimal driving speed for each section and a charging time at each charging station and generates optimized path information.

15. The log data-based electric vehicle energy consumption analysis and path exploration system of claim 14, wherein the path optimization module dynamically adjusts a driving speed pattern in consideration of a driving scenario including highway driving, city driving, and hill section driving.
